(19) United States
(12) Patent Application Publication
(10) Pub. No.: US 2012/0169036 A1
(43) Pub. Date: Jul. 5, 2012

(54) METHOD AND A DEVICE FOR PREPARING SHEET MATERIAL TO BE USED FOR A PAGE OF A BOOK, A PRINTING PAPER SHEET FOR A PAGE OF A BOOK, AND A BOOK

(75) Inventors: Henri Huotari, Espoo (FI); Markuu Siikamäki, Espoo (FI); Iisakki Huotari, Espoo (FI)

(73) Assignee: Maoing Kommandiittiyhtio L. Huotari, Espoo (FI)

(21) Appl. No.: 13/395,544

(22) PCT Filed: Sep. 10, 2010
(86) PCT No.: PCT/IB2010/054101

§ 371 Date: Mar. 12, 2012

(30) Foreign Application Priority Data
Sep. 11, 2009 (EP) 09170139.1

(51) Int. Cl. B42D 1/00; B31F 1/10; B42C 5/00

(52) U.S. Cl. 281/2; 493/463; 493/320; 281/38; 281/40

(57) ABSTRACT

A method for preparing sheet material (10, 80) to be used for a page of a book comprises forming—in essentially an even sheet material (10, 80) adapted for use in a modern printing method in which the sheet material (10, 80) runs through a set of cylinders and/or rolls—at least one hinge area (18), extending for a distance (L, K+L) from the edge (14) of the sheet material (10, 80) that is intended as the binding edge of a book, towards the center of the sheet material (10, 80), by making, in the hinge area (18) of the sheet material (10, 80), several weakenings (11) that are parallel to the edge (14), are adjacent to each other and are located at increasing distances with respect to each other from the edge of the sheet material (10, 80) intended as the binding edge of a book, by making the weakenings (11): a) without piercing the sheet material (10, 80) and without essentially removing fibers from the sheet material (10, 80) in the hinge area (18), and b) in such a way that at least some of the weakenings (11) remain visible as protrusions and/or feel like protrusions when tested by the finger. In addition, independent patent claims for the device, the printing paper sheet and the book.

### TECHNICAL FIELD

The invention relates to the field of graphical technology, particularly to the book binding field.

### BACKGROUND INFORMATION

A stapled book does not usually remain open when it is opened on a table. This is due to the fact that the pages are fastened to the spine of the book which, unlike the situation with a stitch-bound book, is stiff and does not give way when opening the book. Many users find this unpleasant.

The challenge of ensuring that even a book made with a stiff spine remains open when it has been opened on a table has remained unsolved as technical graphical equipment has been developed. With new equipment it is possible to make books profitably, even in short series. Combined with digital image processing and the opportunities offered by the Internet, the demand for and supply of photo books, for example, has in fact grown very strongly.

When printing with a modern printing method, the printing paper sheet runs through a set of cylinders and/or rolls. The gaps between the cylinders of a set of cylinders and the rolls of a set of rolls are very narrow, for which reason modern printing techniques are only adapted to essentially even sheet material. Depending on the printing technology selected, the printing ink or coloring agent applied to the sheet material may also be heated. Methods such as these set tough demands on the sheet material used in printing, and on their surface.

One earlier solution for ensuring that a book remains open is described in the international patent application WO 2008/109657. The page of a book that remains open comprises a hinge area from which material has been removed. Each page is coated with film. The pages of this kind of book remain open, but are turned very easily, even too easily. When the book is held in the hand, it may feel like a fan. In addition, the use of a film that is required as a stiffener may increase the load on the environment when the book is removed from use. A practical problem from the perspective of modern printing technology for the sheet described in international patent application WO 2008/109657 may also be that, when placing the sheet in a printing device made according to modern printing technology, with the hinge area at the front, the susceptibility of the printing device to disturbances may increase.

### SUMMARY

One objective of the invention is to enable the making of a book that easily remains open, by means of modern printing technology in which the sheet material runs through a set of cylinders and/or rolls, and in such a way that the book can also still be bound relatively simply. This objective can be achieved by preparing, for the pages of a book, essentially even sheet material, adapted for use in a modern printing method in which the sheet material runs through a set of cylinders and/or rolls, by a method according to the first independent patent claim or by a device according to the second independent patent claim.

The above-mentioned objective can also be achieved by a printing paper sheet made according to a parallel independent patent claim. A book made according to the parallel independent patent claim easily remains open and can be simply bound.

In the method according to the invention, in order to prepare sheet material to be used for a page of a book, a hinge area is formed from essentially even sheet material which is adapted for use in a modern printing method in which the sheet material runs through a set of cylinders and/or rolls. The hinge area extends for a distance from the edge of the sheet material intended as the binding edge of the book towards the center of the sheet material. The hinge area is formed by making, in the hinge area of the sheet material, several weakenings that are parallel to the edge, are adjacent and are located respectively at increasing distances from the edge of the sheet material intended as the binding edge of a book. The weakenings are made a) without piercing the sheet material and without essentially removing fibers from the sheet material in the hinge area, and b) in such a way that at least some of the weakenings remain visible as protrusions and/or feel like protrusions when tested by the finger.

A device according to the invention for preparing sheet material to be used for a page of a book comprises hinge-area-forming means adapted to form a hinge area extending for a distance from the edge of the sheet material that is intended as the binding edge of a book, towards the center of the sheet material. The hinge-area-forming means is adapted to make, in the hinge area of the sheet material, several weakenings that are parallel to the edge, are adjacent and are located respectively at increasing distances other from the edge of the sheet material intended as the binding edge of a book. The hinge-area-forming means is adapted to make weakenings a) without piercing the sheet material and also without essentially removing fibers from the sheet material, and b) in such a way that at least some of the weakenings remain visible as protrusions and/or feel like protrusions when tested by the finger.

A printing paper sheet according to the invention is essentially even and is adapted for use in a modern printing method in which the sheet runs through a set of cylinders and/or rolls. A printing paper sheet comprises a hinge area, extending for a distance from the binding edge of the sheet towards the center of the printing paper sheet. The sheet material comprises, in the hinge area, several weakenings that are parallel to the binding edge, are adjacent, are located at increasing distances with respect to each other from the binding edge of the sheet, and are made a) without piercing the printing paper sheet and also without essentially removing fibers from the printing paper sheet, and b) in such a way that at least some of the weakenings remain visible as protrusions and/or feel like protrusions when tested by the finger.

A book according to the invention comprises i) a front cover and a back cover and a book spine that joins them, in such a way that, between the front cover and the back cover, and fastened to the spine of the book or to the inner covers, are many printing paper sheets according to the invention, which form some or all of the pages of the book, or ii) a block of printing paper sheets according to the invention, which form some or all of the pages of the book, as well as the cover leaves to which the block is fastened.

### ADVANTAGES OF THE INVENTION

A printing paper sheet for a page of a book according to the invention and a method and a device for preparing sheet material according to the invention are better than the printing paper sheet, method and device described in international patent application WO 2008/109657 since, by making adjacent weakenings in the hinge area instead of one wide hinge, it is possible to more successfully avoid the ‘fan effect’ in the ready book pages that is caused by the wide area of weakness and that is difficult to control. In addition, the hinge area of a printing paper sheet according to the invention now under discussion can be more easily printed with modern printing techniques in which the sheet runs through a set of cylinders and/or rolls.

FIGS. 15 and 16 illustrate a possible problem of a sheet described in the international patent application WO 2008/109657. When the book is standing upright on the top of the table 152, the page 151 of the book will remain upright. But when the table top 151 is removed, for example when the book is held in the hand and opened, the hinge area 150 can, under the influence of gravity g give way so much that the page 151 sags. The hinge area 150 can expand at its upper part and contract at its lower part perpendicularly towards the reader or away from the reader, with respect to the level shown in FIG. 16. The probability of this phenomenon will grow when the book's page 151 is sufficiently large. In the way shown in FIGS. 17 and 18, a printing paper sheet 10 according to the invention now under discussion will not sag when the book is held in the hand and opened.

With a device, method and sheet according to the invention it is also possible to gain the surprising additional advantage that the fastening of the sheets to form the pages of a book by using mechanical fastening means—for example, staples or channel binding—is easier. By using channel binding, in which a block of pages is fastened together by pressing the block from the opposite side with a fastening body, preferably a collar, the sliding of the pages from the fastening element can be prevented more easily. If it is desired to fasten a block of pages to each other by staples, sheet material processed with a device or a method according to the invention can be fastened with one staple to make a thicker block than is possible with normal sheets, if the staple is applied in a linear weakening, for the material allows the staple to sink deeper.

The dependent claims describe advantageous embodiments of the invention.

According to one advantageous embodiment, the location and/or the form of the weakenings increases/increase the pliability of the sheet material in the hinge area around lines parallel to the edge of the sheet material between the parts intended as the top edge and the bottom edge of a page of the book.

According to one advantageous embodiment, at least some of the weakenings are made by stretching or distending the sheet material along the weakenings. When stretching or distending the sheet material, it is not necessary to remove material. Due to this, it is possible to make a relatively simple device for use in preparing the sheet material, and in using the method the amount of waste produced decreases and the cleanliness of the operating environment improves.

According to one advantageous embodiment, at least some of the weakenings are longitudinal. Preferably, the longitudinal weakenings are grooves or comprise grooves. The longitudinal weakenings can be implemented most practically by compressing or rolling the sheet material. By compressing or rolling the sheet material, the preparation can be done without removing material from the sheet material.

According to one advantageous embodiment, the weakenings are implemented by balanced forming of the sheet material in such a way that the stresses potentially arising in the sheet material run essentially parallel to the hinge area. Due to this, it is possible to more easily avoid the waving of the sheet material when printing on the sheet material.

According to one advantageous embodiment, the weakenings are made by increasing the porosity of the fiber layer of the sheet material at the protrusions, compared with the part of the sheet material outside the hinge area.

As a result of the above-presented embodiments, there is no need to essentially remove fibers from the hinge area of the sheet material in order to make weakenings, and the sheet material is not pierced. Due to this, the tearing out of pages in the finally resulting book can be more easily avoided. When printing the sheet with a modern printing method, in which the sheet material runs through a set of cylinders and/or rolls, it is thus also possible to avoid the excessive weakening of the tensile strength of the sheet material. In addition, when the weakenings are implemented by using grooves, it is possible to avoid disturbances in the printer induced by printing ink or coloring agent more easily than would be the case if the weakenings were made by using perforation, for example.

The inventors have noticed that, when printing on simply grooved sheet material, it can easily happen that multiples of the grooves are printed out along the print at even distances. In practice, this makes an unsuitable end result for any purpose in which the end product must be high-quality.

The inventors have also noticed that the print on simply grooved sheet material can easily become uneven, particularly for modern printing methods including a heating phase.

The inventors have noticed to their surprise that both of the above-mentioned problems can be fixed very successfully if the form and running properties of the sheet material are restored in the hinge area or along the weakenings in the hinge area before printing. Most advantageously this is done by compressing the hinge area or the weakenings in it, in such a way as to affect the arrangement of the fibers in the sheet material and thus to be able to influence the porosity of the fiber layer.

When using modern printing methods in which the sheet runs through a set of cylinders and/or rolls, the first problem of inkjet printing, for example, is that the printing ink may accumulate at the bottom of the groove more and thereby cause problems in the print. The second problem that may appear in inkjet printing is that, when the surface of the printing paper sheet is uneven, the ink spreads in different ways into the protrusions and recesses. In laser printing the problem is that the coloring agent does not necessarily stick and/or go to the bottom of the recesses properly. In addition, the fastening unit is not able to fasten the coloring agent at the bottom of the recesses properly. The best end result is obtained by compressing the hinge area or the weakenings in it in such a way that the porosity of the fiber layer of the sheet material decreases in the area between the protrusions.

According to an advantageous embodiment, it is therefore possible to significantly improve the printability of the sheet material by compressing the hinge area or the weakenings in the hinge area after making the weakenings. Compression decreases the unevenness of the surface of the sheet material along the weakenings without compromising the ability of the weakenings to make the pages remain open. Due to the compression, the porosity of the fiber layer of the sheet material can be restored in the area outside the peaks of the protrusions so as to almost correspond with the porosity of the fiber layer of the unprepared sheet material. Due to the restoration, the coloring agent or printing ink can be spread evenly, in which case there is a better guarantee of the undisturbed, uninterrupted operation of the printer or printing machine. This is particularly important when using modern printing methods in which the sheet material runs through a set of cylinders and/or rolls or also in which the printing ink or coloring agent is fixed to the sheet material by heating. The advantage is highlighted when the printing surface extends into the hinge area. Another advantage of compressing the hinge area is that the grooves are more unobtrusive. In addition, if the sheet material is or includes a coated paper grade, it is possible through compression to decrease any weakening influence on the print caused by cracks arising in the coating when making the weakenings.

By printing the sheet material only after making the grooves or compressing the weakenings, it is thus possible to advance directly to the binding of the book, without needing to do the grooving after printing. In that case, it is essential that the sheet material is still even enough after preparation that it is adapted for use in a modern printing method in which the sheet material runs through a set of cylinders and/or rolls. Thus it is possible after printing to advance to a cutting phase or even directly to binding and covering. If the sheets have been grooved already or if their form and running properties have also been restored, then no separate grooving means may be needed in the book binding workshop.

By making the weakenings in the sheet material on its opposite sides, it is possible to prevent the sheet material from taking a convex form. As a result, the printability and processability of the sheet material improves considerably. A particularly good end result is achieved when adjacent weakenings in the sheet material are made from opposite sides. Most advantageously, the method of choosing the weakenings is selected in such a way that the sheet material tends to remain straight and/or in such a way that the sheet material does not tend to buckle. Thus it is easier to prevent the sheet material from being caught up in the printing machinery, between the cylinders or rolls, for example, and as a result the printability of the sheet material will be improved.

If individual weakenings of the hinge area of a printing paper sheet extend from the bottom edge to the top edge of the sheet, it is possible to improve the ease of turning the pages of the ready end product, i.e. the book, and the ease with which a spread remains open—since each page's linear weakening can thus act as a folding line for the whole page height.

A book that i) comprises a front cover and a back cover and a book spine that joins them, in such a way that, between the front cover and the back cover, and fastened to the spine of the book or to the inner covers, are many sheets according to the invention, which form some or all of the pages of the book, or that ii) comprises a block of sheets according to the invention, which form some or all of the pages of the book, as well as the cover leaves to which the block is fastened, remains open more easily than a traditional book.

A printing paper sheet and method according to the invention is particularly well suited to the production of photocolor. In a photo book a color or black and white photograph or photographs are developed or printed on at least some—and possibly even all—of the printing paper sheets, using a modern printing method in which the sheet material runs through a set of cylinders and/or rolls. By printing the color or black and white photograph or photographs after the printing paper sheets have first been compressed in the hinge area in order to flatten out the weakenings, it is possible to make the photo book after printing i) (optionally) by cutting the printing paper sheets, ii) by binding individual printing paper sheets into a sheet block and iii) (optionally) by cutting the sheet block edge or edges, and iv) by covering the bound and possibly cut block of printing paper sheets.

When the area of weakenings extends equally as far on each page of the book, it is possible when making the book to avoid a situation in which the pages should be printed in a certain order on certain printing paper sheets. In that case, the sheets could be in the wrong order and the influence of the hinge area in eliminating the stacking effect would not be so good.

Advantageously, the property of easily remaining open can be achieved in a ready book when the hinge area of the printing paper sheets formed by the book pages is implemented in such a way that the distance, for which the hinge area of each printing paper sheet extends from the binding edge of the printing paper sheet, is selected to ensure that the hinge area compensates the stacking effect when browsing through the book. Most simply, the width of the weakenings should be equivalent to the width of the spine of the book.

By means of a device according to the invention the hinge area can be made, as desired, either before printing or after it. Thus, a wider range of paper grades can be used for printing, since, due to the device, the paper grades are not restricted to the available prepared printing paper sheets.

Due to the device, it is easier to guarantee the undisturbed operation of the printer (particularly the paper feed), because the weakenings of the hinge area and the possible restoration of the form and running properties is done only after printing.

The device can also be implemented in such a way that the means for making the weakenings is adjustable and/or exchangeable. Thus it is possible to select, as desired, the width (L) of the weakenings of the hinge area and/or the distance of the weakened part of the hinge area from the edge (K).

### BRIEF DESCRIPTION OF THE DRAWINGS

The following is a more detailed description of the invention with reference to the attached drawings, which are given by way of example. The drawings present:

FIG. 1 is a plan illustration of a single printing paper sheet intended as a page of a book, viewed from the front;

FIG. 2 is an end view of a single printing paper sheet intended as a page of a book, viewed from the top or bottom;

FIG. 3 is an end cross-sectional view of a book in a closed position according to the invention;

FIG. 4 is an end cross-sectional view of a book according to the invention after the book has been opened and the first batch of pages has been browsed by turning from right to left;

FIG. 5 is an end cross-sectional view of the book presented in FIG. 4 after a second batch of pages has been browsed by turning from right to left;

FIG. 6 is a plan view of a book according to the invention, viewed from the front when the book has been opened;

FIG. 7 is a flow chart illustrating the steps of the method to be used when preparing the sheet material to be used for a page of a book;

FIG. 8 is a plan view of an alternative printing paper sheet intended as a page of a book, viewed from the front;

FIG. 9 is a schematic view of a device intended for preparing sheet material, viewed obliquely from the front;

FIG. 10 is a detailed view of the device, showing one embodiment of the means for forming the hinge area;

FIG. 11 is a detailed view from the right-hand side of the device presented in FIG. 9;

FIG. 12 is a detailed view, according to one embodiment, of the means for making weakenings and the means for restoring the form and running properties;

FIG. 13 is a device according to FIG. 9, on whose feeding level is a printing paper sheet to be prepared;

FIG. 14 is a detailed view of how the device prepares sheet material;

FIGS. 15 and 16 are illustrations of a problem related to a sheet known in the prior art;

FIGS. 17 and 18 are illustrations of the behavior of a prepared sheet compared to the prior art shown in FIGS. 15 and 16;

FIG. 19 is a plan view of a sheet material prepared in an alternative way;

FIG. 20 is an end view of a block of prepared printing paper sheets bound by stapling;

FIG. 21 is an end view of the block of prepared printing paper sheets presented in FIG. 20, opened;

FIG. 22 is an end view of the printing paper sheets as shown in FIG. 1, bound into a book by glue binding (perfect binding);

FIG. 23 is an end view of a block of the printing paper sheets presented in FIG. 8;

FIG. 24 is an image taken by a scanning electron microscope of a cross-section of non-prepared sheet material;

FIG. 25 is an image taken by a scanning electron microscope of a cross-section of prepared sheet material; and

FIG. 26 is an image taken by a scanning electron microscope of a cross-section of prepared sheet material, after the restoration of form and running properties.

The same reference numbers refer to the corresponding technical features in all drawings.

### DETAILED DESCRIPTION OF THE PREFERRED EMBODIMENTS

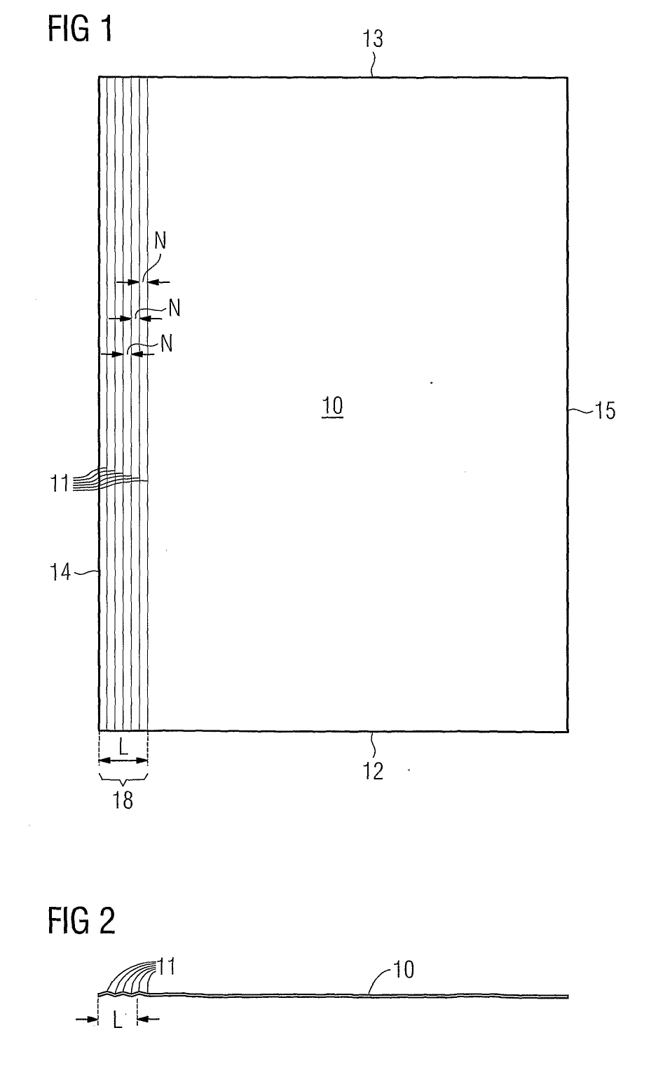

FIG. 1 presents a front view of a single printing paper sheet 10 intended as a page of a book. The printing paper sheet 10 comprises a bottom edge 12, a top edge 13, an edge 14 intended as the binding edge and a freely remaining edge 15. In addition to this, the printing paper sheet 10 comprises a hinge area 18 extending for a distance L from the binding edge 14 of the printing paper sheet 10 towards the center of the printing paper sheet 10, with the hinge area 18 comprising several weakenings 11 that are parallel to the binding edge 14 of the printing paper sheet 10, are adjacent to each other and are located respectively at increasing distances from the binding edge 14 of the printing paper sheet 10.

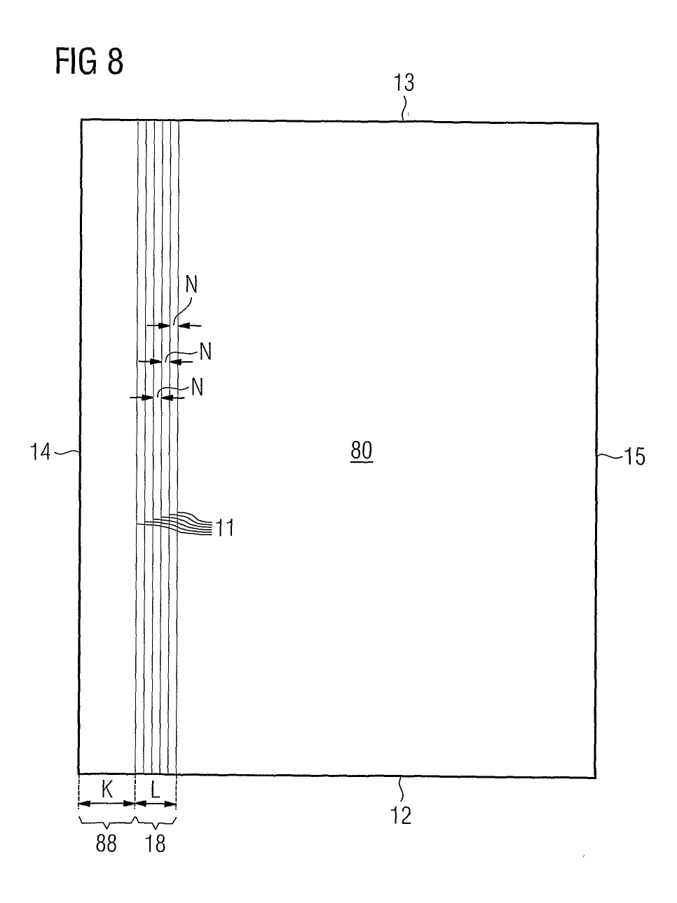

FIG. 8 presents an alternative printing paper sheet 80 intended as a page of a book. The printing paper sheet is otherwise similar to the printing paper sheet 10 presented in FIG. 1, except that the hinge area now comprises not only the weakened part of the hinge area 18, but also the non-weakened area 88 that extends for a distance K from the binding edge 14. Thus, the part of the hinge area 18 equipped with the weakenings actually extends for a distance L+K from the binding edge. The weakenings 11 in the hinge area 18 are located in a similar manner to those presented in FIG. 1 throughout the width L in the sheet 10.

The positioning and/or the form of the weakenings 11 increases/increase the pliability of the sheet material 10, 80 in the hinge area 18 around lines parallel to the edge 14 of the sheet material intended as the binding edge of the printing paper 10, 80, between the parts intended as the top edge 12 and the bottom edge 13 of a page of the book.

According to an advantageous embodiment, at least some of the weakenings 11 are made by stretching, distending or recessing the sheet material along the weakenings 11.

In the printing paper sheets 10, 80 according to FIGS. 1 and 8, the weakenings 11 run longitudinally. They have been implemented as grooves that can be caused by compressing or rolling the sheet material.

The different embodiments of the printing paper sheets 10, 80 are alternative to each other also in the sense that both embodiments can be combined to form a printing paper sheet from which an easily openable book can be obtained and that allows the printing paper sheets to be easily fastened together by stapling, for example.

For the sake of simplicity, however, it may assumed in what follows that the weakenings 11 are distributed over the width L, which may be indented at a distance K from the edge 14 intended as the binding edge of the sheet 10, 80.

The weakenings 11 of the hinge area 18 in the sheets 10, 80 according to FIGS. 1 and 8 are preferably implemented as grooves. Some of the weakenings 11 of the hinge area 18 may also, however, be implemented by using some other method. The grooves are preferably made by pressing or rolling.

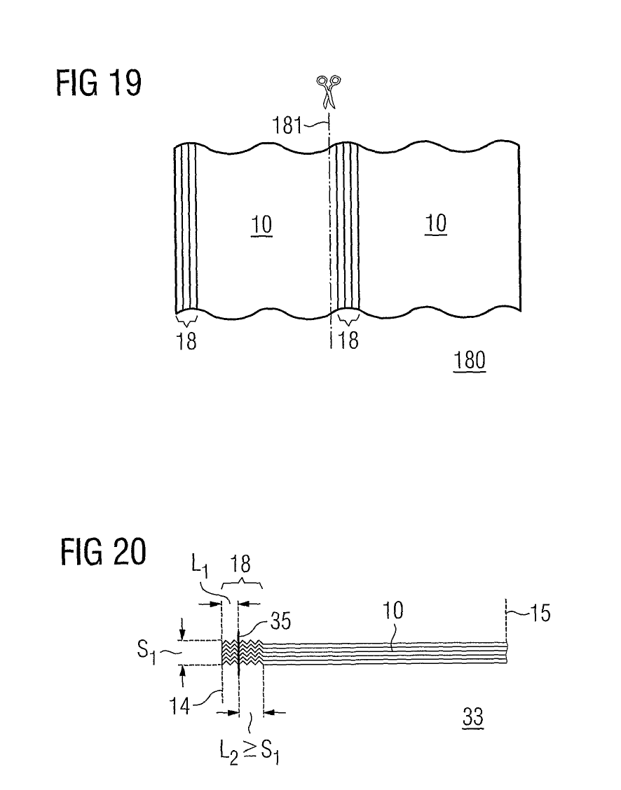

In the description section below—and in the attached drawings—only the reference number 10 will be used generally and for the sake of clarity for the printing paper sheets 10, 80. The printing paper sheet 10 can, logically, be replaced by the sheet 80, depending on the context, or, as proposed above, by combining them. Additionally, the following description uses not only the term ‘printing paper sheet’ 10, but also from time to time the term ‘sheet material’. Sheet material may correspond to the printing paper sheet 10, but in addition it may refer to continuous material such as, for example, the material on a roll from which the printing paper sheets are cut. Moreover, sheet material may refer to wider material from which the printing paper sheets are cut (cf in particular FIG. 19). For the sake of clarity the reference number 10 will also be used for sheet material from now on.

Most advantageously the weakenings 11 will be made as narrow lines (0.3-1.5 mm in width), although, depending on the paper grade, the lines may also have some other width, while the width N of the sheet material 10 remaining between the weakenings 11 will be 0.3-6.0 mm. The width N of the sheet material 10 remaining between the weakenings 11 will therefore be preferably approximately 1-4 times the width of a single weakening 11.

The weakenings 11 of the hinge area 18 can be made, in the way shown in FIG. 2, from the opposite sides of the sheet material 10. Individual longitudinal weakenings 11 of the hinge area 18 can be extended from the bottom edge 12 of the printing paper sheet 10 to the top edge 13 of the printing paper sheet 10.

The weakenings 11 can be implemented as either solid or broken linear weakenings. The weakenings can be extended from the bottom edge 12 of the printing paper sheet 10 to the top edge 13 of the printing paper sheet 10. It is possible, however, that a narrow strip of non-weakened material is left in one or more weakenings at the bottom edge 12 and/or at the top edge 13 of the printing paper sheet 10 in order that the weakenings 11 do not show at the ends of the book.

Advantageously, the weakenings 11 are compressed after they are made in order to improve the printing properties of the sheet material 10 and/or to make the grooves more unobtrusive, and, above all, in order to adjust the sheet material's fiber structure and coating, if any.

Advantageously, the page of a book is printed on the printing paper sheet 10 only after a hinge area 18 has first been made on the printing paper sheet 10, in order that no separate equipment is required in the book binding workshop to make the hinge area 18 and/or to restore the form and running properties.

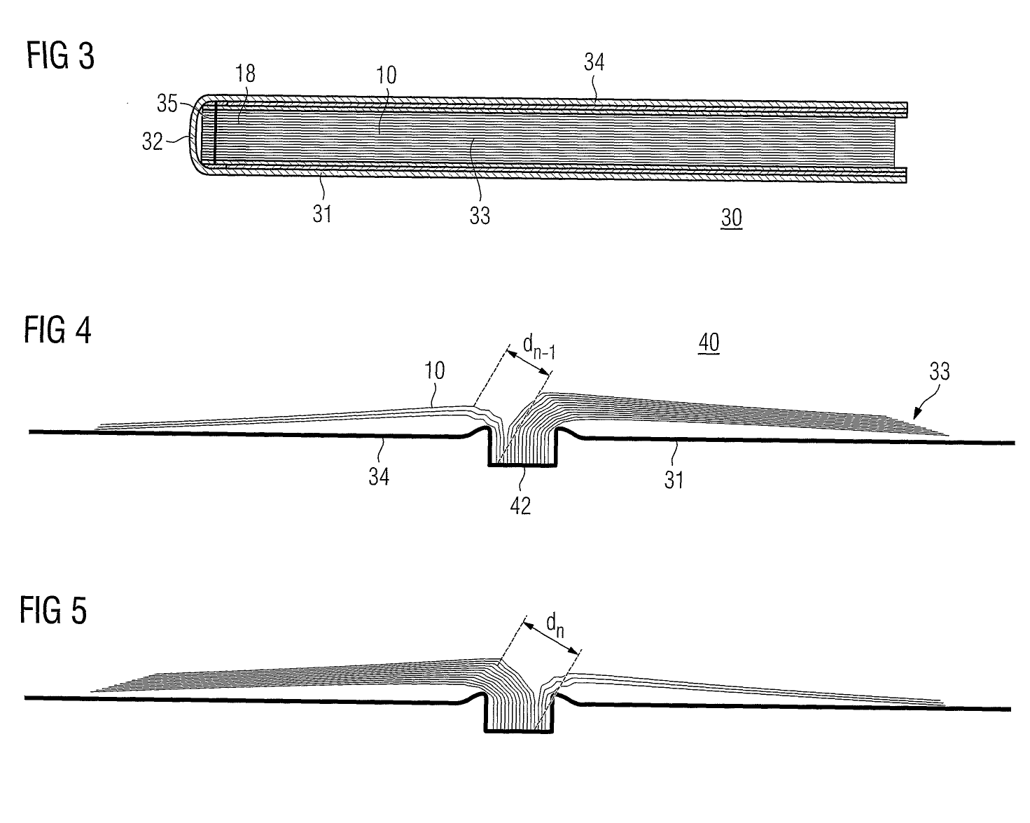

FIG. 3 presents a cross-section of a book 30 according to the invention. The book 30 comprises a block 33 of printing paper sheets 10 which form all or some of the book's pages, and the cover leaves to which the block 33 is fastened. The printing paper sheets 10 of the block 33 can be fastened to each other in the way shown in FIG. 3, and the block 33 can also be fastened by gluing it from the cover leaves to the front cover 34 and the back cover 31, although other fastening methods are also possible. The front cover 34 and the back cover 31 are preferably joined to each other by means of a spine 32, which can be strengthened or unstrengthened.

The staples 35 can be used to fasten the sheets 10 vertically at several points in the hinge area 18.

When using the type of printing paper sheets 80 presented in FIG. 8, in which the weakenings have been indented at a distance K from the edge 14 intended as the binding edge of the printing paper sheet, the staples 35 can also fasten the printing paper sheets 80 in the non-weakened part 88 of the hinge area.

In a book 30 according to FIG. 3, the printing paper sheets 10 are fastened to each other by staples 35. Instead of or in addition to stapling the sheets, it is also possible to bind or glue the printing paper sheets 10 to each other.

Alternatively and in the way shown in FIG. 4, a book 40 may comprise a front cover 34, a back cover 31 and a spine 42 joining them. Attached to the spine 32 of the book 40, between the front cover 34 and the back cover 31, are many printing paper sheets 10 according to the invention, which form all or some of the pages of the book 40. Most advantageously the attachment is done by gluing, in particular by hot melt gluing.

The sheets of the book 30, 40 may be completely or partly either the printing paper sheets 10, 80 alone, or their arbitrary combination.

The book 30 or 40 may be a photo book or such in which a color or black and white photograph or photographs are printed on at least some of the sheets 10 by using a modern printing method in which the sheet material runs through a set of rolls and, in addition, possibly by fixing the printing ink or coloring agent to the sheet material 10 by heating. It is advantageous for the final result that the hinge area 22 of the sheet material 10 is compressed in order to flatten out the weakenings 11. When the hinge area 18 is formed from grooves or comprises grooves, the compressing results in the grooves being flattened out.

Most advantageously in the book 30, 40, for each page on which a color or black and white photograph or photographs has been printed or developed on the printing paper sheets 10, the hinge area 18 has been extended equally as far.

In the way shown in FIGS. 4 and 5, the book 30, 40 will easily remain open after the book 30, 40 has been opened or after further browsing has taken place. When browsing through the book 30, 40 and when turning each page, the magnitude of the stacking effect will grow by the thickness of the page's printing paper sheet 10, 80, in the way shown in FIG. 4. As the book's pages will have a tendency to fold at the location of one or more of the weakenings within the area denoted by the distance dₙ₋₁, the book 30, 40 will easily remain open when the first batch of pages has been browsed through.

Correspondingly, when further browsing of the book 30, 40 takes place, there will be a point after a certain number of pages when the open, left-hand side page will preferably fold within the transferred area denoted by the distance dₙ measured from the spine of the book 30, 40 or from the edge of the sheet block 33. As each page of the book 30, 40 will have several weakenings 11 within this area, too, the book 30, 40 will also easily remain open at the page in question.

Depending on the method of making the weakenings and the method of restoring any form and running properties, it may be possible to ensure that the book 30, 40 remains more easily open by smoothing out each spread, or a desired spread, by pressing with the fingers on the opened book 30, 40 in the hinge area 18 of the printing paper sheets 10. Such smoothing and pressing with the fingers seems—due to the changes in the fiber layer and coating, if any, caused by the weakenings 11—to result in the book 30, 40 very easily remaining open.

The compensation of the stacking effect generally means, with respect to the invention, that the hinge area of a page of the book 30, 40 is transferred during browsing of the book in accordance with how many pages of the book 30, 40 have already been browsed. When a new opened page folds by itself or with a small amount of help, so that the book 30, 40 easily remains open, and so that the page does not stand upright, it can be said that the book easily remains open. The folding lines most easily occur at the weakenings 11 when browsing through the book 30, 40.

An easily openable book 30, 40 is most advantageously implemented by ensuring that the width L of the weakenings of the printing paper sheets used is equal to the width of the book's spine. Depending on the method of fastening the pages, the hinge area may be indented at a distance K from the edge 14 intended as the binding edge of the sheets.

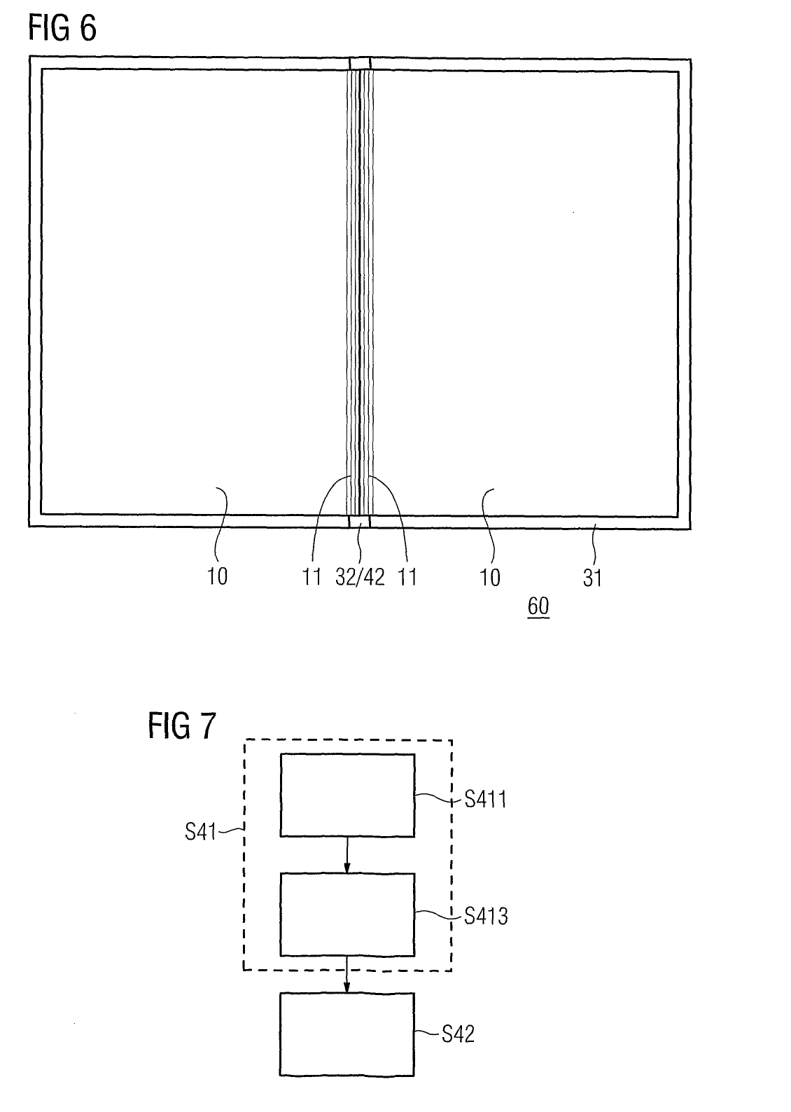

FIG. 6 presents a book 60 according to the invention, opened and viewed from the front. Advantageously the book 60 can be implemented like the book 30 or 40. When the book 60 has been opened, some of the weakenings 11 are visible.

The advantage of the above-presented books 30, 40 is self-evident. The books 30, 40 can be implemented without any special arrangements to compensate for the rigidity of the book's spine.

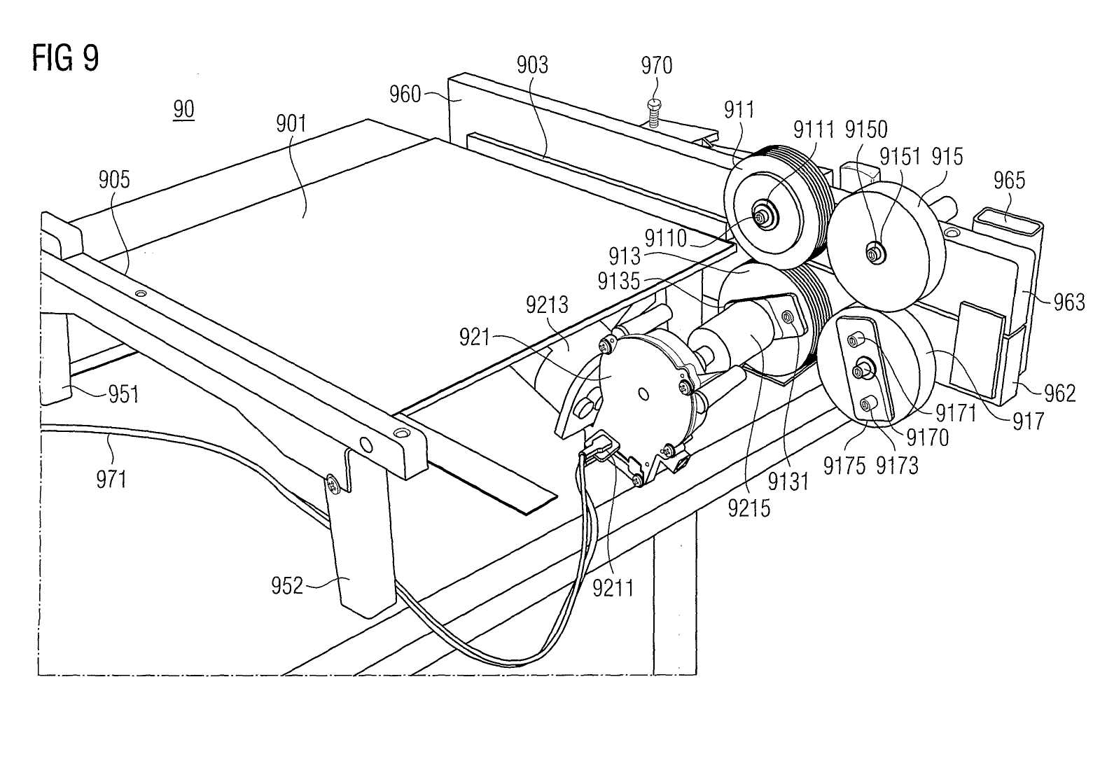

FIG. 7 shows the steps of the method to be used when preparing the sheet material to be used for a page of a book. The method can be used in connection with a device 90 according to FIG. 9, for example.

During the phase S411, the weakenings 11 are made in the sheet material 10 from the first side. During an optional phase S413, the weakenings 11 are made in the sheet material 10 from the other side of the sheet material 10.

The phases S411 and S413 of the method are implemented most simply by combining them into phase S41, in which case the weakenings are made in the sheet material 10 in the same work phase, from both sides of the sheet material 10.

The weakenings 11 are made by increasing the porosity of the sheet material 10 at the protrusions compared with the part outside the hinge area 18 of the sheet material 10. In addition, the weakenings 11 are made without piercing the sheet material 10 and also without essentially removing fibers from the sheet material 10.

During the phase S42, which is advantageous for the final result, the form and running properties of the sheet material 10 in the hinge area 18 or at the weakenings 11 in it are restored. Most advantageously this is done by compressing the hinge area 18 or the weakenings 11 in it, so that the porosity of the fiber layer of the sheet material 10 decreases in the area between the protrusions. The restoration is done in such a way that the printability and/or running properties of the hinge area 18 differ as little as possible from the part of the sheet material 10 outside the hinge area 18.

The above-presented method can be used for sheet material cut as separate printing paper sheets 10. In that case, the sheet material is preferably prepared by preparing one printing paper sheet 10 at a time.

It is also possible to use the above-presented method for continuous sheet material 10 and to cut the sheet material 10 into single printing paper sheets only after this. Thus, it is easier to automate the process and it may also be possible to process more sheets per unit of time, since the method can be used for sheet material on a roll.

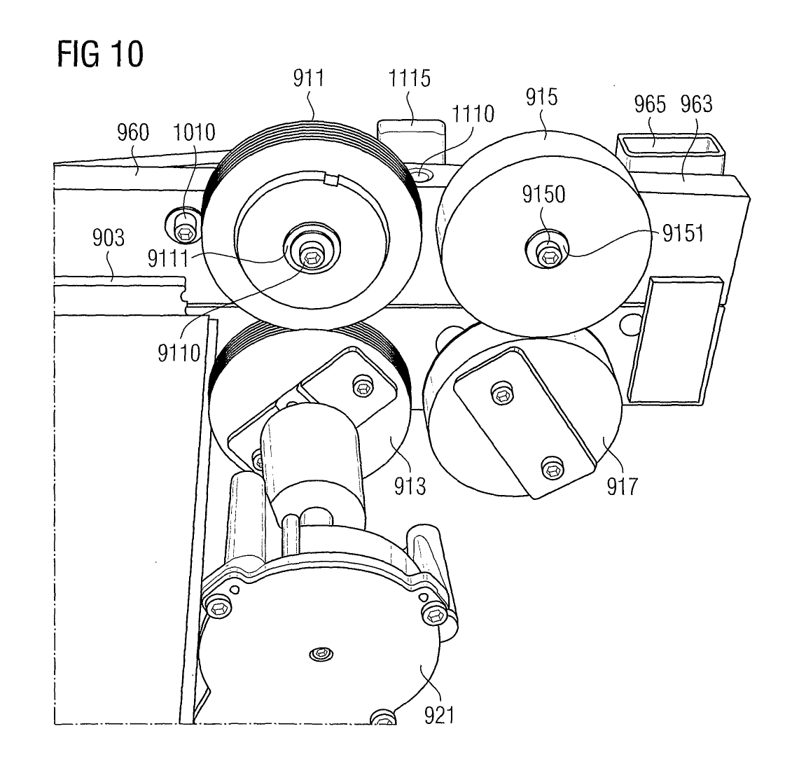

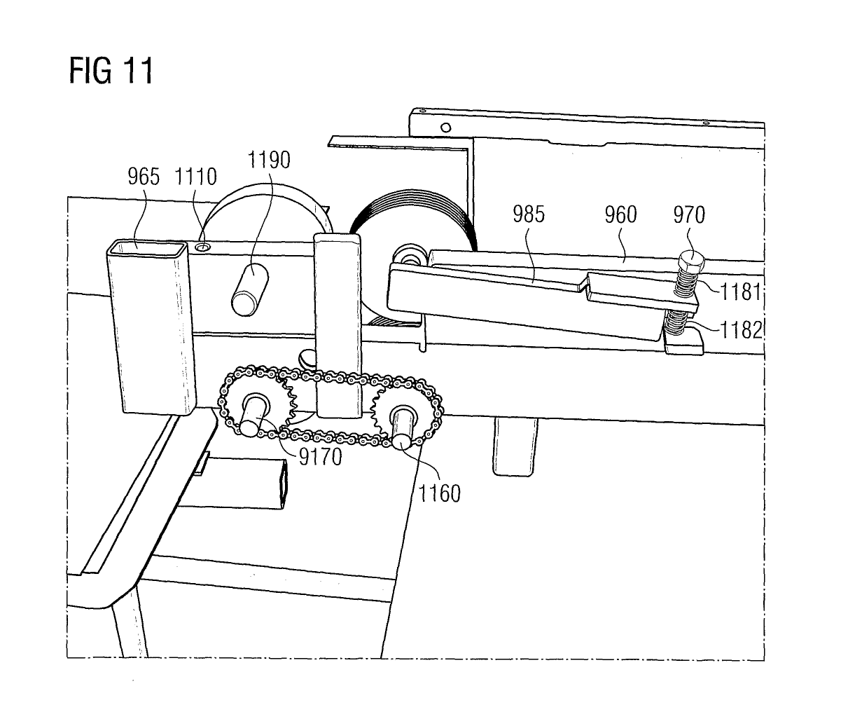

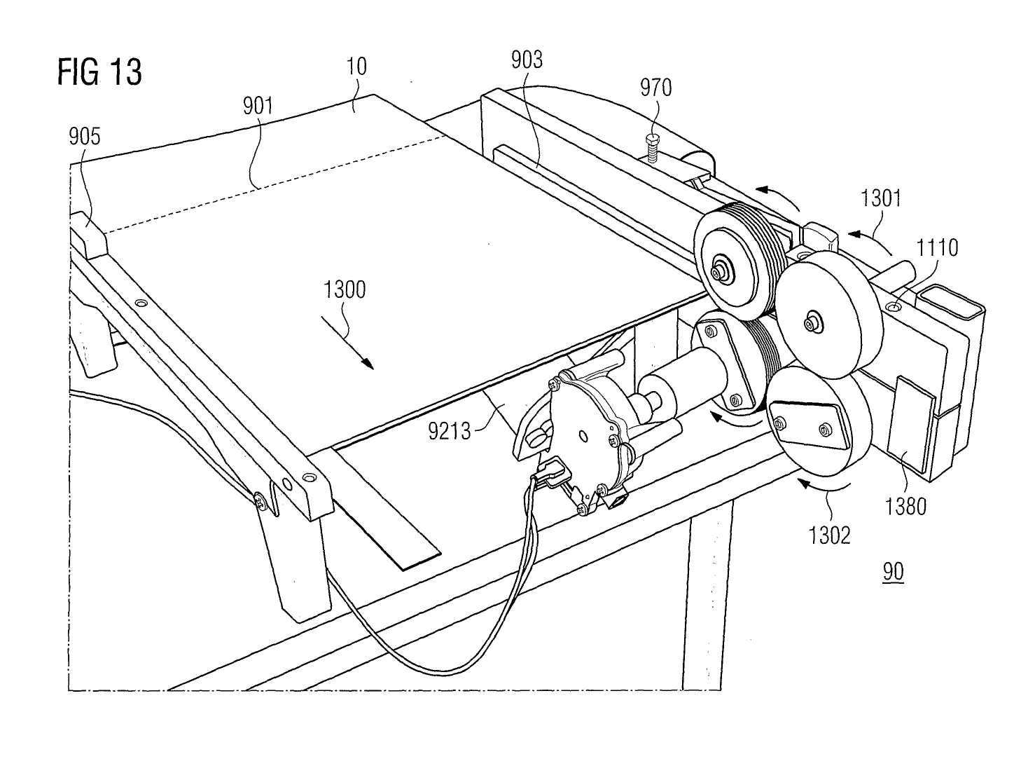

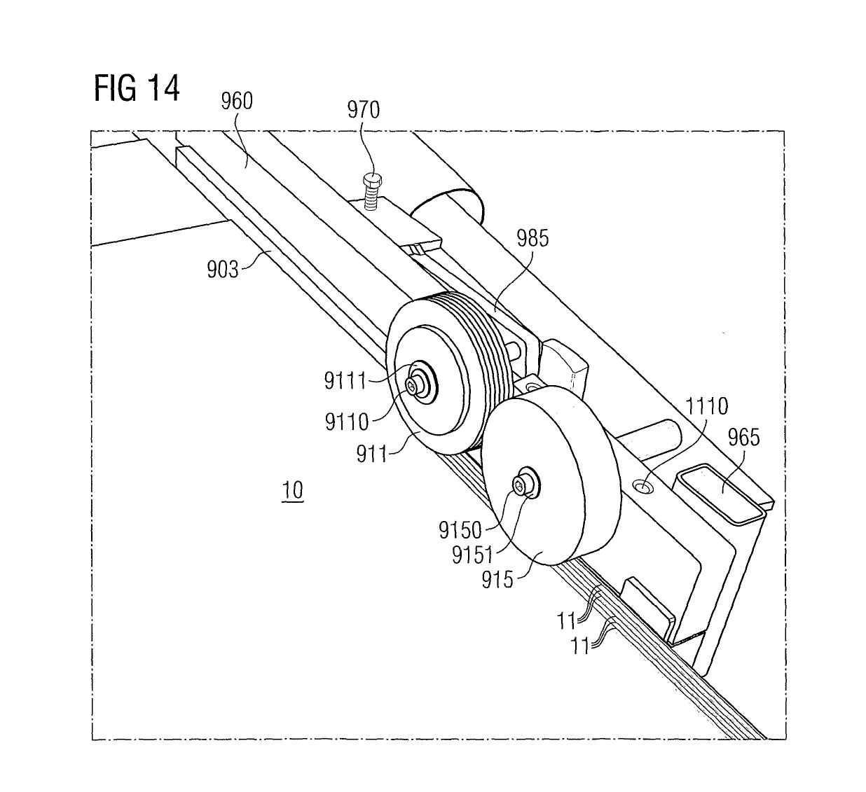

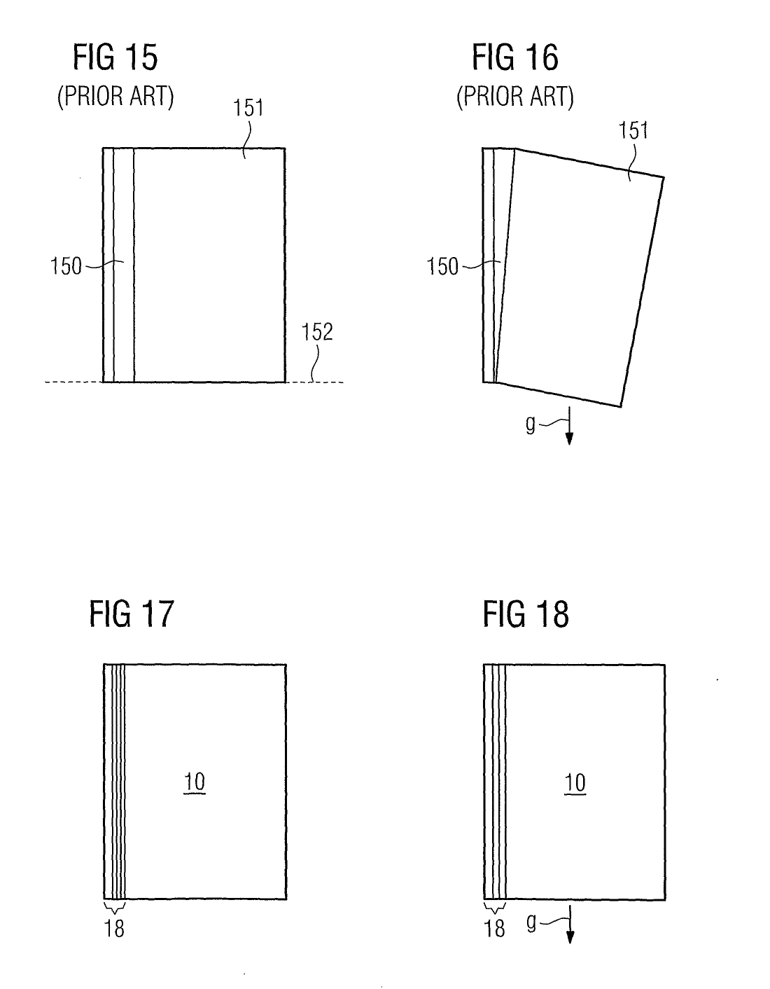

FIG. 9 presents one embodiment of a device 90 for making the hinge area 18; in other words, for preparing the sheet material to be used for the pages of a book. The details of the structure of the device 90 are also presented more exactly in the drawings shown in FIGS. 10-12. FIGS. 13 and 14 illustrate the operating method used by the device 90 to prepare sheet material.

The device 90 comprises a feeding level 901, a first lateral guide 903, a second lateral guide 905, and a unit for forming the hinge area. The hinge-area-forming unit comprises means for making weakenings and optionally also means for restoring the form and running properties of the sheet material.

The means for making weakenings comprises the first grooving roll 911 and the second grooving roll 913. It is also possible to implement the means for making weakenings in such a way, for example, that one of the rolls is actually a smooth or soft counter roll.

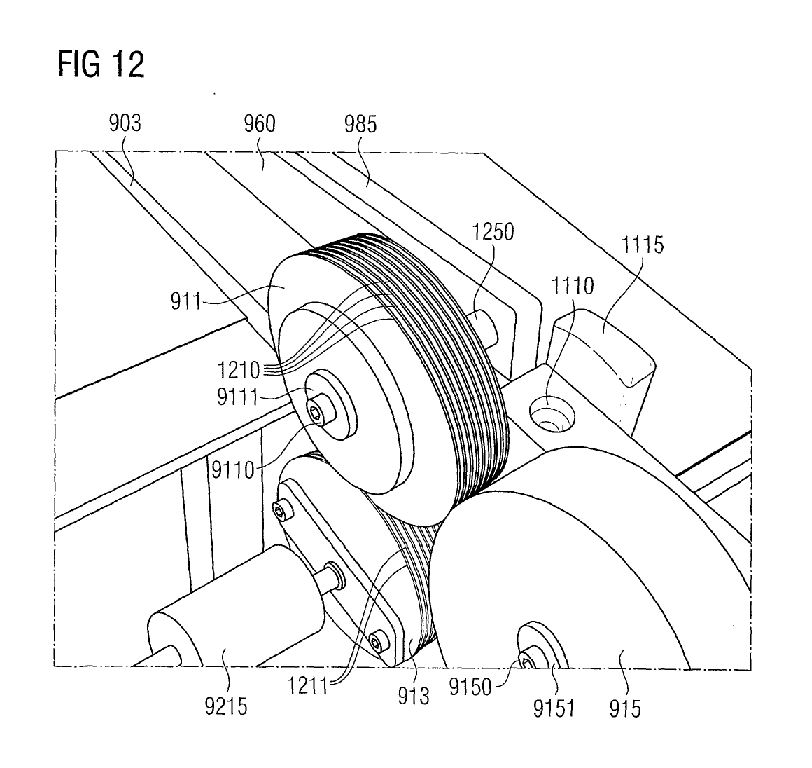

The grooving roll 911 is opposed to the grooving roll 913 and it is off-set against the grooving roll 913 in the way shown in FIG. 12, so that the protrusions 1210 in the grooving roll 911 fit between the protrusions 1211 in the grooving roll 913.

Means for restoring the form and running properties are advantageously a part of the device 90 or are attachable to it. This is implemented most simply in such a way that the device 90 comprises the first press roll 915 and the second press roll 917. The press roll 915 and the press roll 917 are set against each other. The press rolls 915, 917 are preferably smooth rolls.

The grooving rolls 911, 913 and the press rolls 915, 917 are made from material that does not color or soil the sheet material to be processed, or are coated with such material. This kind of material is stainless steel, for example.

The device 90 further comprises means for rotating the first grooving roll 913. At its most simple, the means comprises a crank handle or pulley block, but advantageously the means for rotating the grooving roll 913 comprises an electric motor 9213 and preferably also a gearbox 921 connected to the electric motor. The rotation means, particularly the gearbox 921 and/or the electric motor 9213, can be connected via an installation sleeve 9215 to an attachment flange 9135, which is fastened by fastening devices 9131 such as screws to the grooving roll 913. It is possible, for example, to select a 24 V direct current motor producing 5 Nm torque as the electric motor 9213.

According to an advantageous embodiment the grooving roll 913 is connected to power transmission means in order to rotate the press roll 917. This can be done, for example, by means of a sprocket wheel 1135 that can be attached to the axle 1160 of the grooving roll 913, and a sprocket wheel 1140 that can be attached by pressing to the axle 9170 so that the sprocket wheel 1135 is connected to the sprocket wheel 1140 with a chain 1199 or any other suitable power transmission means. The axle 9170 can be attached to an attachment flange 9175, which is attached by attachment devices 9171, 9173 such as screws to the press roll 917. The axles 9170 and 1160 are most advantageously placed in through-holes made in the framework beam 962, in which case it is also possible to arrange support for the axles 9170, 1160 and to brace the grooving roll 913 and the press roll 917 by means of the axles 9170, 1160 so that they are sufficiently solidly in place when using the device 90.

By using power transmission means such as that presented, it is possible to achieve synchronization of the grooving roll 913 and the press roll 917. By selecting the size of the grooving roll 913 and the press roll 917, as well as the sprocket wheels 1140, 1135 used so that the surfaces of the grooving roll 913 and the press roll 917 rotate at the same speed at the location of the sheet material placed on top of the feeding level 901, it is possible to prevent the mashing of the sheet material between the grooving roll 913 and the press roll 917. Synchronization can be implemented in other ways, too.

The second grooving roll 911 can be implemented as a free roll. The grooving roll 911 rotates freely around the axle 1250. The washer 9111 is attached by an attachment device 9110, for example by a screw, to the end of the axle 1250 to restrict the axial movement of the roll. The axle 1250 is firmly attached via the through-hole of the framework beam 960 to the spring shaft 985 whose compressive force can be adjusted by means of adjusting devices 970, 1181, 1182 such as screws and springs that are preferably preformed springs. Thus, the pressure of the grooving roll 911 against the grooving roll 913 can be adjusted to accord with the sheet material 10 to be prepared by the device 90.

The second press roll 915 can be implemented as a free roll. The press roll 915 is attached by means of the washer 9151 and the attachment device 9150 such as a screw rotatably to the axle 1190. The axle 1190 is firmly attached to the framework beam 963 via the through-hole of the framework beam 963.

By arranging the framework beams 962, 963 so that their distance from each other can be adjusted a little, it is possible, in a simple way, to adjust the compressive force between the first press roll 917 and the second press roll 915 by using adjustment devices 1110 such as screws in accordance with the sheet material to be prepared. The adjustment devices 1110 can be implemented with a screw thread and the framework beams 963, 962 can be fastened flexibly to each other by means of the guides 965, 1115 and 1380 attached to the framework beam 963.

The device 90 is equipped with the legs 951, 952, 953 to raise the device above the table top. Thus the electric motor 9213, the power transmission means and above all the lower grooving roll 913 and the lower press roll 917 can be located under the feeding level 901. Space also remains for the electrical connection 9211 of the electric motor 9213 and for the motor's current cable 971, while the feeding level 901 can be installed horizontally. In addition, it is possible to use the feeding level 901 as a supporting surface by means of which the electric motor 9213 can be kept in place.

When the device 90 is used to prepare the sheet material 10, the sheet material 10 is set to run on top of the feeding level 901 between the lateral guides 903, 905 in the way shown in FIG. 13; in other words, the device 90 is used to pull the sheet material 10. By pulling, it is more easily possible to avoid mashing of the sheet material 10 than would be the case if the device 10 pushed the sheet material 10.

The electric motor 9213 rotates the lower grooving roll 913 and press roll 917 in the direction shown by the arrow 1302. In that case, due to the synchronization, the upper grooving roll 911 and press roll 915 will rotate in the direction shown by the arrow 1301; in other words, in the opposite direction to that shown by the arrow 1302. In that case, the sheet material runs through the device 10 in the direction shown by the arrow 1300. Thus running, the sheet material 10 runs first between the grooving rolls 911 and 913 (cf FIG. 14), in which case the weakenings 11 are formed along the length of the sheet material 10. These longitudinal weakenings 11 are then compressed between the press rolls 915 and 917 to even out the weakenings 18.

The grooving rolls 911, 913 are most advantageously adjusted so that they compress the sheet material 10 forced between them in such a way that weakenings 11 are formed in the sheet material 10 so that the grooves acting as the weakenings 11 remain visible as protrusions and feel like protrusions when tested by the finger. Most advantageously, the compression causes clearly greater porosity and even parceling in the fiber layer of the sheet material outside the hinge area 18 of the sheet material 10. In addition, if the sheet material comprises one or more coating layers, at least some of them may crack.

The press rolls 915, 917 are most advantageously adjusted so that they compress the sheet material 10 forced between them in the hinge area 18 in such a way that the porosity of the fiber layer of the sheet material decreases in the area between the protrusions. In addition, if the sheet material 10 comprises one or more coating layers, the compression will diminish the cracks that have arisen in the coating layer or layers.

Most advantageously the grooving rolls 911, 913 and the press rolls 915, 917 are adjusted to act together in such a way that, after the grooving and compressing, the porosity of the sheet material is at its greatest at the peaks where the greatest tensile stresses are directed in the grooving process. In the area between the peaks the porosity will be at the same level as in the unprepared material. If the sheet material comprises one or more coatings, cracks will arise in at least one coating at the peaks, with the result that no significant cracks will appear in the area between the peaks.

The width of the grooving rolls 911, 913 is equivalent to at least the desired width L of the hinge area 18, where it is desired to make the weakenings 11. If it is desired to continue the hinge area 18 by making a non-weakened area 88, whose width is K, in the edge 14 of the sheet material, the grooving rolls 911, 913 and the press rolls 915, 917 are correspondingly transferred the desired distance K further away from the lateral guides 903, for example, by exchanging the axles of the grooving rolls 911, 913 and of the correction rolls 915, 917 for longer axles.

The device 90 can also be implemented in such a way that the grooving rolls 911, 913 and the press rolls 915, 917 are exchangeable for wider or narrower rolls.

One or more of the axles 9170, 1160, 1250, 1190 can be implemented at a longer length for this purpose, so that they extend for a longer distance between the guides 903, 905 in the direction of the feeding track of the running sheet material. All or some of the axles can also be supported on the framework beam on the side of the guide 905. In addition, extra guide rolls or cylinders can be put on the axles 9170, 1160, 1250, 1190, so that the sheet material is not pulled only from one side.

It is also possible to prepare the sheet material 10, 80 in the way shown in FIG. 19, so that two hinge areas 18 are made in it at the same time. Sheet material such as this can be cut along a cutting line 181 into two separate sheets. The device 90 can be implemented in a corresponding way. Indeed, it is also possible to make several (3, 4, 5, . . . ) hinge areas in the sheet material at the same time and then to cut the sheets separately.

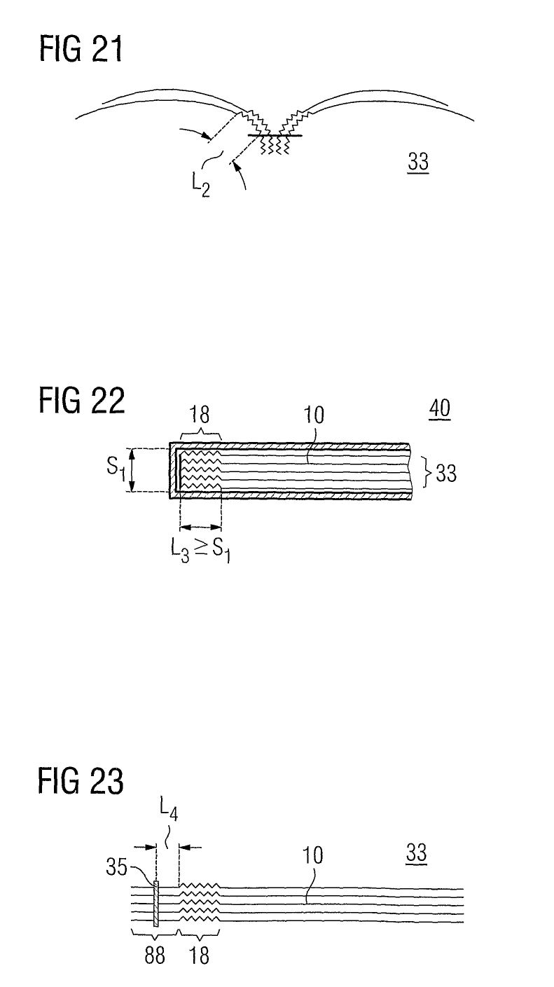

FIG. 20 presents a block 33 of printing paper sheets 10 according to the invention. The printing paper sheets 10 are fastened to each other in the hinge area 18, by staples 35 for example, to form a block 33. If the thickness of the block 33 is S₁, and the fastening point of the staple is at a distance L₁ from the line of the binding edge 14 of the sheet block 33, the weakenings 11 in the hinge area 18 will extend for a distance L₂ from the staple 35 to the line of the front edge 15 of the sheet block 33. In order that the resulting book 30, 40, or the sheet block 33 itself, would very easily remain open, the distance L₂ should be greater or as great as the thickness S₁ of the sheet block 33. In that case, in the way shown in FIG. 21, the weakenings 11 in the hinge area 18 will ensure that the pages easily remain open.

FIG. 22 presents a book 40 according to the invention, which comprises printing paper sheets 10 according to the invention, which are fastened at the binding edge 14 into a block 33. If the thickness of the block is S₁, the width L₃ of the hinge area must be greater or as great as the thickness S₁ of the block, so that the book 40 will very easily remain open.

Correspondingly in the way shown in FIG. 23, if the printing paper sheets 10 according to the invention are fastened into a block 33 for example by stapling them with staples 35 in the non-weakened part 88 of the hinge area 18, the width L₄ of the non-weakened part 88 can be selected so that the width of the area equipped with weakenings in the hinge area 18 is sufficient that the block 33 will very easily remain open.

In order to better understand the phenomenon behind the invention, the processed sheet material was studied in a technical research center. The paper samples were used to make micro cross-sections that were examined by means of a scanning electron microscope (SEM). The samples to be examined were cast in a mold in epoxy resin, the cross-sectional surface of whose hardened samples was ground by sandpaper and finally polished. A scanning electron microscope in the so-called BSE mode, in which the materials with heavier elements such as the coating and the filler look lighter than the materials with lighter element compositions such as fibers and resin, was used for the actual research. The samples also included filler, which shows up as light particles among the fiber structure. Also noticeable from the electron microscope image are some bigger slab-like formations which may be large filler aggregates or part of the coating that has penetrated deep.

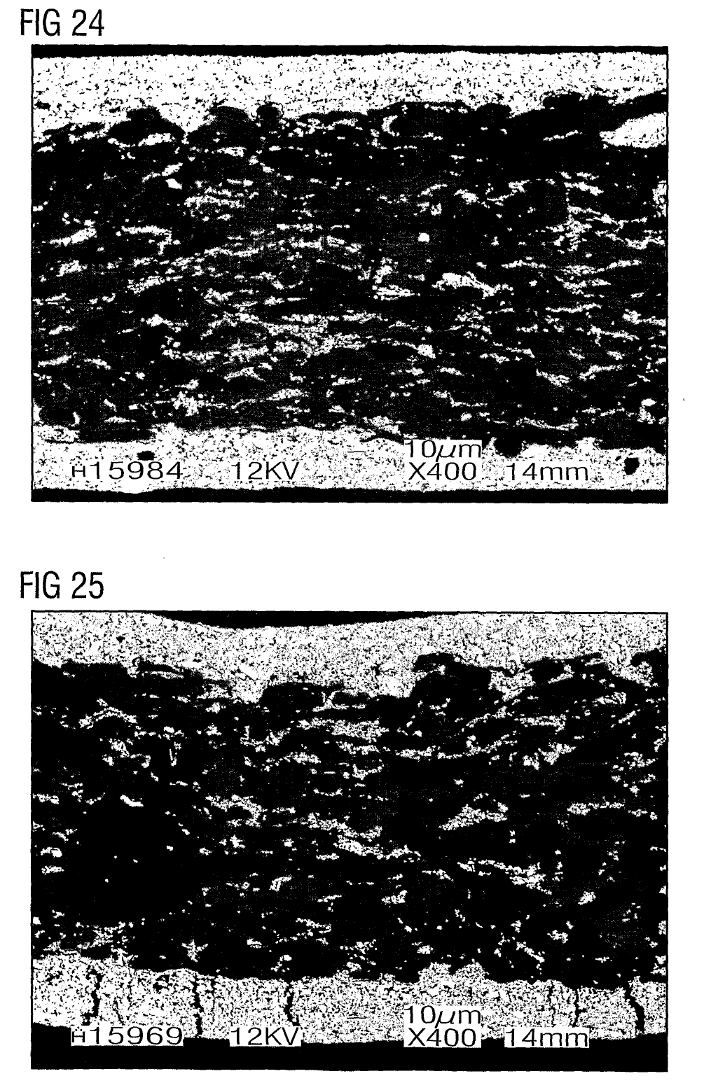

FIG. 24 presents an image taken by the scanning electron microscope of a cross-section of unprepared sheet material. This corresponds to the sheet material 10 presented in FIG. 14 which is just on its way to be processed by the grooving rolls 911, 913.

FIG. 25 presents an image taken by the scanning electron microscope of a cross-section of prepared sheet material. This corresponds to the sheet material 10 shown in FIG. 14 which is processed between the grooving rolls 911, 913 and which is just on its way to be processed by the correction rolls 915, 917. Compared with the sample shown in FIG. 24, the fiber layer of the sheet material shown in FIG. 25 is very clearly more porous. There are also cracks in the coating layer of the sheet material.

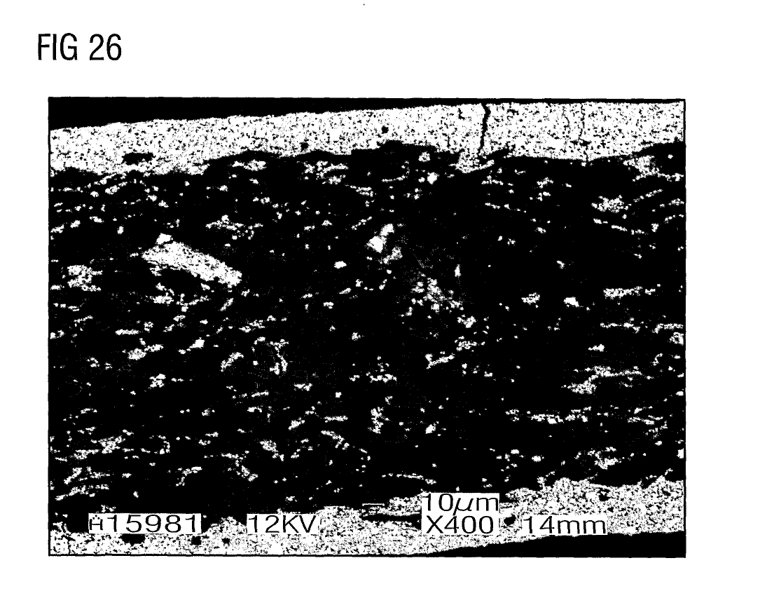

FIG. 26 presents an image taken by the scanning electron microscope of a cross-section of prepared sheet material after the restoration of form and running properties. This corresponds to the sheet material 10 shown in FIG. 14, which has first been processed by the grooving rolls 911, 913 and then by the correction rolls 915, 917. It can be seen from FIG. 26 that the porosity of the fiber layer of the sheet material is now greater than for the sheet material shown in FIG. 24. In addition, there are cracks in the coating layer of the sheet material on the outer edge of the coating layer. The fiber structure of the sheet material shown in FIG. 25 is more porous in the hinge area 18 than the fiber structure of the sheet material shown in FIG. 26. In addition, the sheet material shown in FIG. 25 has more and wider cracks in the hinge area 18.

The porosity of the fiber material of the sheet material shown in FIG. 26 has increased, compared with the sheet material shown in FIG. 24, only at the peaks of the weakenings 11 (grooves). Cracks appear in the coating layer only at the peaks.

The sheet material and the printing paper sheet are most advantageously coated or uncoated paper that is adapted for digital printing (“digiprinting”), particularly for laser, dye sublimation or inkjet printing.

In particular, paper adapted for inkjet printing may have a sandwich type of structure, in particular so that in the center of the sandwich structure there is a plastic membrane or other membrane that is impervious to ink separating the opposite sides of the paper.

This kind of sandwich structure may be coated or uncoated paper.

The foregoing description of the invention is not meant to restrict the protective scope of the patent, but its intention is to contribute to an understanding of what the invention concerns. To those skilled in the art, it is therefore clear that the implementation of the invention may vary in accordance with the spirit of the invention.

### LIST OF REFERENCE NUMBERS

10 printing paper sheet, sheet material

11 longitudinal weakening

12 bottom edge of the printing paper sheet

13 top edge of the printing paper sheet

14 binding edge of the printing paper sheet

15 front edge of the printing paper sheet

18 hinge area

30 book

31 back cover of the book

33 block of printing paper sheets

34 front cover of the book

42 spine of the book

80 printing paper sheet

88 non-weakened area

90 device for the preparation of sheet material

150 hinge area

151 printing paper sheet

152 table top

901 feeding level

903 lateral guide

905 lateral guide

911 grooving roll (free roll)

913 grooving roll (drive roll)

915 press roll

917 press roll

921 motor's gearbox

951 leg of the device

952 leg of the device

953 leg of the device

960 framework beam

965 guide

970 screw

971 motor's current cable

985 spring shaft

1010 screw

1110 screw

1115 guide

1135 sprocket wheel

1140 sprocket wheel

1160 axle

1181 compression spring

1182 compression spring

1190 axle

1199 chain

1210 protrusions

1211 protrusions

1250 axle

1300 direction of movement of sheet material

1301 direction of rotation of rolls

1302 direction of rotation of rolls

9110 screw

9111 washer

9131 screw

9170 axle

9171 screw

9173 screw

9175 attachment flange

9135 attachment flange

9150 screw

9151 washer

9215 installation sleeve

Modifications and substitutions by one of ordinary skill in the art are considered to be within the scope of the present invention, which is not to be limited except by the allowed claims and their legal equivalents.

1. A method for preparing sheet material (10, 80) to be used for the page of a book, characterized in that the method comprises the following step:
forming—in essentially even sheet material (10, 80) adapted for use in a modern printing method in which the sheet material (10, 80) runs through a set of cylinders and/or rolls—at least one hinge area (18), extending for a distance (L, K+L) from the edge (14) of the sheet material (10, 80) that is intended as the binding edge of a book, towards the center of the sheet material (10, 80), by making, in the hinge area (18) of the sheet material (10, 80), several weakenings (11) that are parallel to the edge (14), are adjacent to each other and are located respectively at increasing distances from the edge of the sheet material (10, 80) intended as the binding edge of a book, by making the weakenings (11):
a) without piercing the sheet material (10, 80) and without essentially removing fibers from the sheet material (10, 80) in the hinge area (18); and
b) in such a way that at least some of the weakenings (11) remain visible as protrusions and/or feel like protrusions when tested by the finger.

2. The method according to claim 1, wherein the positioning and/or the form of the weakenings (11) increases/increase the pliability of the sheet material (10, 80) in the hinge area (18) around lines parallel to the edge (14) of the sheet material (10, 80) between the parts intended as the top edge (12) and the bottom edge (13) of a page of the book; and/or
wherein at least some of the weakenings (11) are made by stretching or distending the sheet material (10, 80) along the weakenings (11); and/or
wherein at least some of the weakenings (11) are longitudinal, and preferably such that the weakenings (11) are grooves or comprise grooves—which weakenings (11) are preferably caused by compressing or rolling the sheet material (10, 80); and/or
wherein the weakenings are implemented by balanced forming of the sheet material (10, 80) in such a way that the tensions possibly arising in the sheet material (10, 80) run essentially parallel to the hinge area (18); and/or
wherein the weakenings (11) are made by increasing the porosity of the fiber layer of the sheet material (10, 80) at the protrusions, compared with the part of the sheet material (10, 80) outside the hinge area (18).

3. The method according to claim 1, which further includes the following step: restoring—after making the weakenings (11)—form and running properties in the sheet material (10, 80) throughout the hinge area (18) or along weakenings (11) in the hinge area (18), most advantageously by compressing the hinge area (18) or weakenings (11) in it, most advantageously in such a way that the porosity of the fiber layer of the sheet material (10, 80) decreases in the area between the protrusions.

4. The method according to claim 1, further including the following step:
printing on the sheet material (10, 80) after making weakenings (11) or after restoring form and running properties.

5. The method according to claim 1, wherein the weakenings (11) are made in the sheet material (10, 80) from its opposite sides, most advantageously in such a way that the sheet material (10, 80) tends to remain straight and/or in such a way that the sheet material (10, 80) does not tend to buckle.

6. A device (90) for preparing sheet material to be used for the page of a book, characterized in that the device (90) comprises hinge-area-forming means (911, 913, 915, 917), adapted to form—in essentially even sheet material (10, 80) adapted for use in a modern printing method in which the sheet material (10, 80) runs through a set of cylinders and/or rolls—at least one hinge area (18) extending for a distance (L, K+L) from the edge (14) of the sheet material (10, 80) that is intended as the binding edge of a book, towards the center of the sheet material (10, 80), by making, in the hinge area (18) of the sheet material (10, 80), several weakenings (11) that are parallel to the edge (14), are adjacent to each other and are located respectively at increasing distances from the edge of the sheet material (10, 80) intended as the binding edge of a book; the hinge-area-forming means (911, 913, 915, 917) is adapted to make weakenings (11) a) without piercing the sheet material (10, 80) and also without essentially removing fibers from the sheet material (10, 80), and b) in such a way that at least some of the weakenings (11) remain visible as protrusions and/or feel like protrusions when tested by the finger.

7. The device (90) according to claim 6, wherein the hinge-area-forming means (911, 913, 915, 917) comprises at least one device (911, 913) for making weakenings,
whose location and/or form is selected in such a way that the use of the device (911, 913) for making weakenings increases, with respect to the hinge area (18), the pliability of the sheet material (10, 80) to be prepared, around lines parallel to the edge (14) between the top edge (12) and the bottom edge (13); and/or
which is adapted to stretch or distend the sheet material (10, 80) in order to make the weakenings (11); and/or
which comprises means for making longitudinal weakenings (11), preferably at least one grooving device (911, 913)—which grooving device (911, 913) preferably comprises means adapted to compress or roll the sheet material (10, 80), and particularly advantageously comprises opposed grooving rolls (911, 913); and/or
which is adapted for balanced forming of the sheet material (10, 80), in such a way that the tensions possibly arising in the sheet material (10, 80) run essentially parallel to the hinge area (18); and/or
which is adapted to make weakenings (11) by increasing the porosity of the fiber layer of the sheet material (10, 80) at the protrusions, vis-à-vis the part of the sheet material (10, 80) outside the hinge area (18).

8. The device (90) according to claim 6, wherein the hinge-area-forming means (911, 913, 915, 917) comprises at least one device (915, 917)—located on the running track of the sheet material, after at least one device (911, 913) for making weakenings—for restoring the form and running properties of the sheet material (10, 80) in the hinge area (18) or along the weakenings (11) in the hinge area (18); most advantageously the said at least one device (915, 917) for restoring the form and running properties comprises means—preferably opposed press rolls—for compressing the weakenings (11) of or in the hinge area (18), and most advantageously can be adapted to decrease the porosity of the fiber layer of the sheet material (10, 80) in the area between the protrusions.

9. The device (90) according to claim 8,
wherein at least one device (911, 913) for making weakenings and at least one device (915, 917) for restoring the form and running properties are adapted to cause compression in the sheet material (10, 80), the magnitude of which can be regulated for the device (911, 913) for making weakenings and for the device (915, 917) for restoring the form and running properties, independent of each other; and/or
wherein at least one device (911, 913) for making weakenings and at least one device (915, 917) for restoring the form and running properties are in the same running line (903, 905) for sheet material (10, 80) in the device (90), enabling the device (90) to prepare the sheet material (10, 80) as the sheet material (10, 80) makes a single run through the device (90).

10. The device (90) according to claim 6, wherein at least one device (911, 913) for making weakenings is adapted to cause—in the hinge area (18) of the sheet material (10, 80)—weakenings (11) from opposite sides of the sheet material (10, 80), most advantageously in such a way that the sheet material (10, 80) tends to remain straight and/or in such a way that the sheet material (10, 80) does not tend to buckle.

11. A printing paper sheet (10, 80) for the page of a book, characterized in that: the printing paper sheet (10, 80) is essentially even and is adapted for use in a modern printing method in which the sheet runs through a set of cylinders and/or rolls; and comprises a hinge area (18), extending for a distance (L, K+L) from the binding edge (14) of the printing paper sheet (10, 80) towards the center of the printing paper sheet (10, 80), such that the printing paper sheet (10, 80) comprises, in the hinge area (18), several weakenings (11) that are parallel to the binding edge (14) of the sheet (10, 80), are adjacent, are located respectively at increasing distances from the binding edge (14) of the printing paper sheet (10, 80), and are made a) without piercing the printing paper sheet (10, 80) and also without essentially removing fibers from the printing paper sheet (10, 80), and b) in such a way that at least some of the weakenings (11) remain visible as protrusions and/or feel like protrusions when tested by the finger.

12. The printing paper sheet (10, 80) according to claim 11.
wherein the location and/or the form of the weakenings (11) increases/increase the pliability of the printing paper sheet (10, 80) in the hinge area (18) around lines parallel to the edge (14) between the top edge (12) and the bottom edge (13); and/or
wherein at least a part of the printing paper sheet (10, 80) is stretched, distended or sunk along the weakenings (11); and/or
wherein at least some of the weakenings (11) are longitudinal, and preferably such that the weakenings (11) are grooves or comprise grooves, which are preferably caused: by compressing or rolling the sheet material (10, 80); and/or
the porosity of the fiber layer of the printing paper sheet (10, 80) at the protrusions is greater than in the part outside the hinge area of the printing paper sheet (10, 80); and/or
the porosity of the fiber layer of the printing paper sheet (10, 80) between the protrusions is smaller than at the protrusions, preferably such that the porosity of the fiber layer approaches the porosity of the fiber layer in the part outside the hinge area (10, 80).

13. A book (30), characterized in that the book (30) comprises:
a front cover (34) and a back cover (31) and a book spine (32) that joins them, in such a way that, between the front cover (34) and the back cover (31), and fastened to the spine (32) of the book or to the inner covers, are many printing paper sheets (10, 80) according to claim 11, which form some or all of the pages of the book.

14. The book according to claim 13,
which is a photo book or a book in which a color or black and white photograph or photographs has/have been developed or printed on at least some of the sheets (10, 80) by a modern printing method in which the sheet material runs through a set of cylinders and/or rolls; and/or
has/have been developed or printed on the printing paper sheets (10, 80) by a modern printing method in which the sheet material runs through a set of cylinders after the weakenings (11) have been made in the sheet material (10, 80) in the hinge area (18); and/or
in which, for each page on which a color or black and white photograph or photographs has/have been developed or printed on the printing paper sheet (10, 80), the hinge area (18) extends equally as far.

15. The book (30) according to claim 13, wherein the hinge area (18) of the sheets (10, 80) is implemented in such a way that the distance (L), for which the hinge area (18) of each sheet (10, 80) extends from the binding edge (14) of the sheet (10, 80), has been selected in such a way that the hinge area will compensate the stacking effect when browsing (dₙ₋₁ □□ dₙ) through the book (30), preferably so that the width (L) of the weakenings (11) of the hinge area (18) are equivalent to the width of the spine (35) of the book (30) or exceed the width of the spine (35) of the book (30).

16. A book (30), characterized in that the book (30) comprises:
a front cover (34) and a back cover (31) and a book spine (32) that joins them, in such a way that, between the front cover (34) and the back cover (31), and fastened to the spine (32) of the book or to the inner covers, are a block of printing paper sheets (10, 80) according to claim 11 which form some or all of the pages of the book, as well as the cover leaves to which the block is fastened.
